(19) United States
(12) Patent Application Publication
(10) Pub. No.: US 2025/0150929 A1
(43) Pub. Date: May 8, 2025

(54) WIRELESS NETWORK AND METHOD FOR BACKHAUL NETWORKING

(71) Applicant: Realtek Singapore Private Limited, Singapore (SG)

(72) Inventor: Yang-Jie LIU, Singapore (SG)

(21) Appl. No.: 18/756,123

(22) Filed: Jun. 27, 2024

(30) Foreign Application Priority Data
Nov. 2, 2023 (CN) 202311449536.7

(51) Int. Cl. H04W 40/12; H04L 41/12; H04W 84/18

(52) U.S. Cl. CPC H04W 40/12; H04L 41/12; H04W 84/18

(57) ABSTRACT

A method for backhaul networking includes obtaining a communication quality parameter and a bandwidth parameter of each network node; obtaining a topological connection relationship of the network nodes in a mesh topology; obtaining a connection quality parameter of a connection between each network node and adjacent network nodes thereof in the topological connection relationship and between each network node and an idle node; obtaining candidate paths of the idle node in the mesh topology in accordance with the topological connection relationship; calculating a path quality parameter of each candidate path in accordance with the connection quality parameter of each connection in each candidate path; and selecting one of the candidate paths as a networking path for the idle node according to the path quality parameters of the candidate paths to join the mesh topology of the wireless network.

### CROSS-REFERENCE TO RELATED APPLICATION

This non-provisional application claims priority under 35 U.S.C. § 119(a) to Patent Application No. 202311449536.7 filed in China, P.R.C. on Nov. 2, 2023, the entire contents of which are hereby incorporated by reference.

### BACKGROUND

### Technical Field

The instant disclosure is related to wireless network techniques, in particular to a wireless network and a method for backhaul networking.

### Related Art

A wireless network includes multiple network nodes. These nodes form multiple backhaul paths in accordance with the topology thereof, and an idle node can be joined to the wireless network through one of the backhaul paths. However, transmission efficiencies of the backhaul paths are easily affected by bandwidths, communication qualities, frequency channels, and topological types of the backhaul paths. Consequently, how to select a backhaul path with the optimum transmission efficiency (such as with the optimum data transmission rate) from the backhaul paths as a networking path for the idle node to be joined to the wireless network is an issue.

### SUMMARY

In view of the above, the instant disclosure provides a wireless network and a method for backhaul networking. In one or some embodiments, the wireless network comprises a plurality of network nodes. The network nodes are interconnected to form a mesh topology. One of the network nodes which is defined as a controller node type (also referred to as a controller node) is configured to: obtain a communication quality parameter and a bandwidth parameter of each of the network nodes; obtain a topological connection relationship of the network nodes in the mesh topology; obtain a connection quality parameter of a connection between each of the network nodes and an adjacent network node thereof in the topological connection relationship and a connection quality parameter of a connection between each of the network nodes and an idle node in accordance with the communication quality parameters, the bandwidth parameters, and a connection quality look-up table; obtain a plurality of candidate paths of the idle node in the mesh topology in accordance with the topological connection relationship, wherein the candidate paths are formed by connecting different combinations of the network nodes with the idle node; calculate a path quality parameter of each of the candidate paths in accordance with the connection quality parameter of each of the connections in each of the candidate paths; and select one of the candidate paths as a networking path for the idle node according to the path quality parameters of the candidate paths to join the mesh topology. The connection quality look-up table comprises a bandwidth reference, a plurality of connection quality references and three communication quality ranges. The connection quality references correspond to the bandwidth reference and the three communication quality ranges.

The method for backhaul networking is applicable to a wireless network. In one or some embodiments, the wireless network comprises a plurality of network nodes. The network nodes are interconnected to form a mesh topology. The method comprises: obtaining a communication quality parameter and a bandwidth parameter of each of the network nodes; obtaining a topological connection relationship of the network nodes in the mesh topology; obtaining a connection quality parameter of a connection between each of the network nodes and an adjacent network node thereof in the topological connection relationship and a connection quality parameter of a connection between each of the network nodes and an idle node in accordance with the communication quality parameters, the bandwidth parameters, and a connection quality look-up table; obtaining a plurality of candidate paths of the idle node in the mesh topology in accordance with the topological connection relationship, wherein the candidate paths are formed by connecting different combinations of the network nodes with the idle node; calculating a path quality parameter of each of the candidate paths in accordance with the connection quality parameter of each of the connections in each of the candidate paths; and selecting one of the candidate paths as a networking path for the idle node according to the path quality parameters of the candidate paths to join the mesh topology of the wireless network. The connection quality look-up table comprises a bandwidth reference, a plurality of connection quality references and three communication quality ranges. The connection quality references correspond to the bandwidth reference and the three communication quality ranges.

As above, one or some embodiments of the instant disclosure take into consideration the communication quality parameter and the bandwidth parameter which correspond to each of the connections in each of the candidate paths. As a result, one or some embodiments of the instant disclosure can select the candidate path which has the optimum transmission efficiency (such as one having the optimum path quality parameter) from the candidate paths as the networking path for the idle note to be joined to the mesh topology of the wireless network. Consequently, overall performance of the wireless network can be enhanced. One or some embodiments of the instant disclosure further takes into consideration a channel parameter value corresponding to a channel of each of the connections in each of the candidate paths. As a result, one or some embodiments of the instant disclosure can even more accurately select the candidate path which has the optimum transmission efficiency (such as one having the optimum path quality parameter) from the candidate paths as the networking path for the idle note to be joined to the mesh topology of the wireless network. Consequently, overall performance of the wireless network can be further enhanced.

In some embodiments, the network node which is defined as the controller node type (hereinafter referred to as a controller node) among the network nodes merely needs to store a small number of references and threshold values (such as the first communication quality threshold value, the second communication quality threshold value, the connection quality reference, and the bandwidth reference). Alternatively, in some other embodiments, the controller node merely needs to store a look-up table (hereinafter referred to as a connection quality look-up table) indirectly formed by these small number of references and threshold values. As a result, the connection quality parameter of each of the connections in each of the candidate paths can be calculated or looked up through stored reference values and threshold values or stored connection quality look-up table. Therefore, one or some embodiments of the instant disclosure can reduce storage burden of the controller node.

In some embodiments, compared with using a modulation and coding scheme index (MCS index) cross reference table to look up the connection quality parameter (such as an MCS index) of each of the connections in each of the candidate paths, the connection quality parameter of each of the connections in each of the candidate paths is calculated or looked up through the small number of references and threshold values stored by the controller node (such as the first communication quality threshold value, the second communication quality threshold value, the connection quality reference, and the bandwidth reference) or the connection quality look-up table which is stored by the controller node and indirectly formed by the small number of references and threshold values. As a result, computation time and look-up time of the controller node can be reduced, and thus a consumption of computation resources of the controller node can be reduced.

Some embodiments of the instant disclosure can adjust the path quality parameter of each of the candidate paths through a connection spacing number between each of the connections and the root node in each of the candidate paths and a hop adjustment parameter. As a result, after the idle node is joined to the mesh topology of the wireless network, the topological type of the mesh topology can lean toward being a linear topology or a star topology.

### BRIEF DESCRIPTION OF THE DRAWINGS

The instant disclosure will become more fully understood from the detailed description given herein below for illustration only and therefore not limitative of the instant disclosure, wherein:

FIG. 1 illustrates a schematic structural diagram of a wireless network according to some embodiments of the instant disclosure;

FIG. 2 illustrates a schematic diagram of a single network node according to some embodiments of the instant disclosure;

FIG. 3 illustrates a flow chart of a backhaul networking method according to some embodiments of the instant disclosure;

FIG. 4 illustrates a flow chart of a controller node obtaining various parameters of a backhaul station of each network node according to some embodiments of the instant disclosure;

FIG. 5 illustrates a flow chart of a controller node establishing a logical topology relationship according to some embodiments of the instant disclosure;

FIG. 6 illustrates a schematic structural diagram of a wireless network according to some embodiments of the instant disclosure;

FIG. 7 illustrates a flow chart of calculating a path quality parameter of each candidate path and selecting a networking path according to some embodiments of the instant disclosure;

FIG. 8 illustrates a flow chart of calculating a connection quality parameter of a connection between each network node and an adjacent network node thereof in the topological connection relationship and between each network node and an idle node according to some embodiments of the instant disclosure; and

FIG. 9 illustrates a schematic diagram of a modulation and coding scheme index cross reference table (IEEE 802.11ax MCS index table) of a standard protocol according to a comparative embodiment of the instant disclosure.

### DETAILED DESCRIPTION

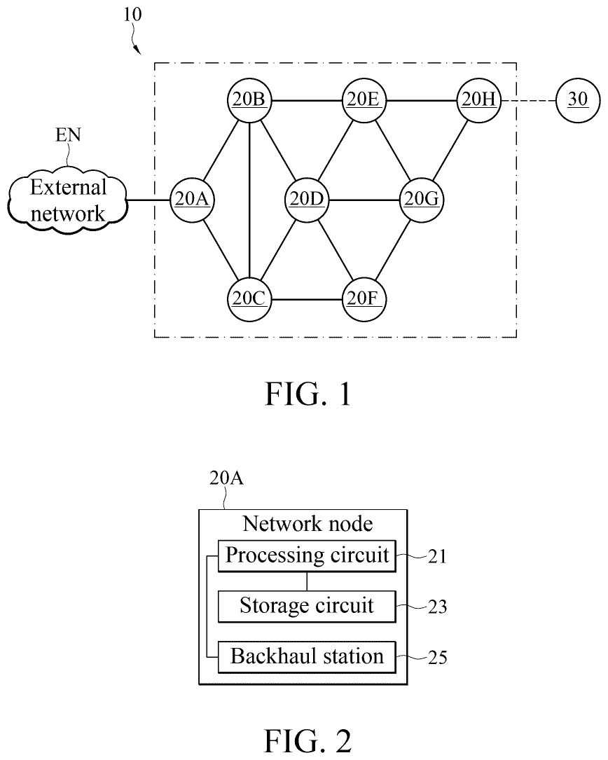

Please refer to FIG. 1. FIG. 1 illustrates a schematic structural diagram of a wireless network 10 according to some embodiments of the instant disclosure. The wireless network 10 includes a plurality of network nodes (also referred to as access points) 20A-20H. The network nodes 20A-20H are interconnected to form a mesh topology. The network nodes 20A-20H are connected to an external network EN through the mesh topology. Although eight network nodes 20A-20H are illustrated in FIG. 1, the present disclosure is not limited thereto, and the number of the network nodes may be less or greater than eight in accordance with the demand of a user. The wireless network 10 is for example a Wi-Fi EasyMesh. The network nodes 20A-20H are for example devices with packet forwarding function and packet receiving function, such as routers or gateways. The external network EN is for example a wide area network (WAN), and the wireless network 10 may be a local network. The connection among the network nodes 20A-20H is a wireless communication connection. The wireless communication connection is for example a Wi-Fi communication connection.

In one or some embodiments of the instant disclosure, a device which has not yet become a network node in the wireless network 10 is referred to as an “idle node”, such as an idle node 30 shown in FIG. 1. In one or some embodiments of the instant disclosure, the term “networking” will be described, and this term refers to a process of joining the idle node 30 to the wireless network 10. In one or some embodiments of the instant disclosure, the term “root node” will be described, and this term refers to a network node which is connected to the external network EN, i.e., the first one of network nodes through which data is transmitted from the external network EN to the wireless network 10, such as the network node 20A shown in FIG. 1. In one or some embodiments of the instant disclosure, the term “hop number” will be described, and this term refers to a number of times of transmission for a data transmission between two nodes.

Please refer to FIG. 2. FIG. 2 illustrates a schematic diagram of a single network node 20A according to some embodiments of the instant disclosure. Because the structures of the network nodes 20A-20H are similar to the structure of the idle node 30, for the sake of conciseness, FIG. 2 merely illustrates the schematic diagram of the network node 20A. In some embodiments, each of the network nodes 20A-20H and the idle node 30 comprises a processing circuit 21, a storage circuit 23, and a backhaul station (backhaul STA) 25. The processing circuit 21 is electrically connected to the storage circuit 23 and the backhaul STA 25. The backhaul STA 25 of each of the network nodes 20A-20H and the idle node 30 is adapted to allow communication connections among the backhaul STAs 25 of the network nodes 20A-20H and the idle node 30. Specifically, in some embodiments, the backhaul STA 25 provides wireless communication function. For example, the backhaul STA 25 is implemented using a wireless communication interface. For example, the network nodes 20A-20H and the idle node 30 each has at least one antenna and thus can perform wireless communication connection with the backhaul STA 25 of each other through the antenna. The processing circuit 21 may be implemented using an operational circuit such as a central processor, a microprocessor, or an application specific integrated circuit (ASIC) so as to control the operation of the node. The storage circuit 23 may be implemented using various volatile memories or nonvolatile memories so as to store data of the node.

For easy illustration, the following description will be illustrated with a scenario where the wireless network 10 has three network nodes 20A-20C.

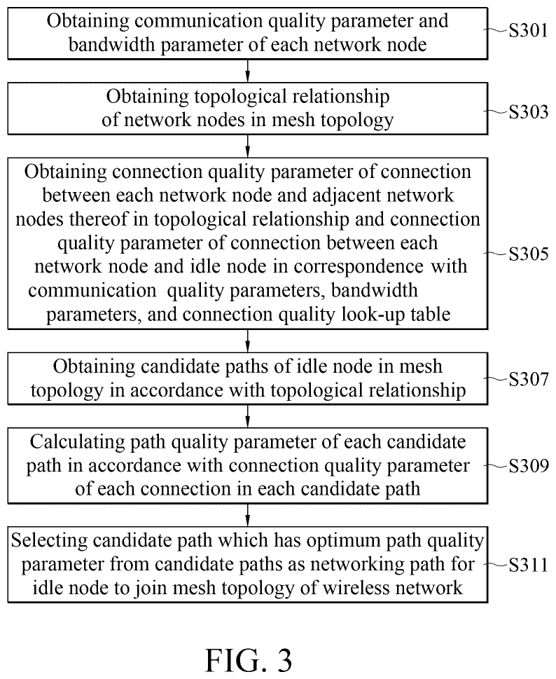

Please refer to FIG. 3. FIG. 3 illustrates a flow chart of a backhaul networking method according to some embodiments of the instant disclosure. The backhaul networking method is applied to the wireless network 10 and adapted to be executed by one of the network nodes 20A-20C which is defined as a controller node type. For example, the network nodes 20A-20C has configuration files. The configuration files are adapted to define node types of the network nodes 20A-20C. The node types include the controller node type and an agent node type. An exemplary embodiment will be illustrated below with the wireless network 10 being the Wi-Fi EasyMesh. According to a protocol of the Wi-Fi EasyMesh, the network nodes 20A-20C may be categorized as the controller node (i.e., the network node which is defined as the controller node type in accordance with the configuration file) and agent nodes (i.e., the network nodes which are defined as the agent node type in accordance with the configuration files). The controller node is adapted to connect the agent nodes to the Wi-Fi EasyMesh and manage the operation of the agent nodes. For example, the controller node manages operating channels of the agent nodes, a structure of data flow topology, and a roaming among the network nodes 20A-20C.

In the following descriptions, a scenario where the network node 20C is taken as the controller node and the network nodes 20A, 20B are taken as the agent nodes is used for illustration.

First, the controller node obtains a communication quality parameter and a bandwidth parameter of each of the network nodes 20A-20C (the step S301). In some embodiments, the controller node further obtains channel information of each of the network nodes 20A-20C. For example, the controller node obtains the communication quality parameter, the bandwidth parameter, and the channel information from the backhaul STA 25 of each of the network nodes 20A-20C in accordance with unassociated STA link metric regulations and operating channel regulations in an IEEE 1905 protocol and a Wi-Fi EasyMesh protocol. The communication quality parameter is for example a received signal strength indication (RSSI) of the backhaul STA 25 of each of the network nodes 20A-20C. The channel information is for example an operating channel of the backhaul STA 25 of each of the network nodes 20A-20C, such as a 2.4G channel or a 5G channel. The bandwidth parameter is for example a bandwidth value of the backhaul STA 25 of each of the network nodes 20A-20C.

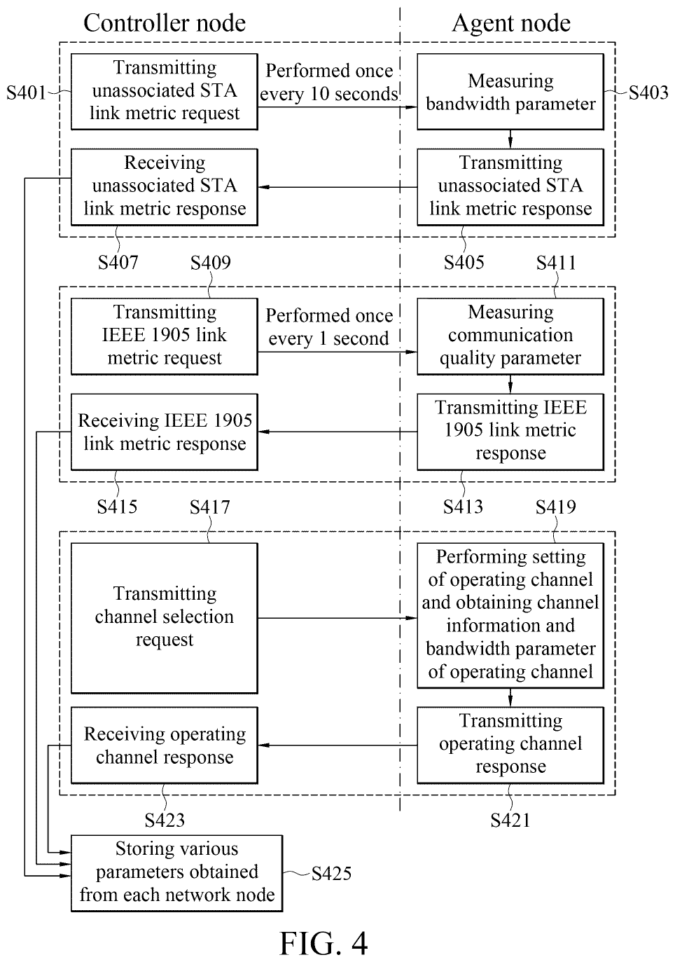

Please refer to FIG. 4. FIG. 4 illustrates a flow chart of the controller node obtaining various parameters of the backhaul station 25 of each of the network nodes 20A-20C according to some embodiments of the instant disclosure. In FIG. 4, the steps which are in columns assigned to a specific device are the steps performed by the specific device. For example, portions which are denoted in the “controller node” columns are the steps performed by the controller node; and portions which are denoted in the “agent node” columns are the steps performed by the agent node.

For example, as shown in FIG. 4, the controller node transmits an unassociated STA link metric request to the agent nodes in accordance with the unassociated STA link metric regulations (the step S401). Each of the agent nodes measures the bandwidth parameter of the backhaul STA 25 thereof every ten seconds in response to the unassociated STA link metric request (the step S403). Next, each of the agent nodes places the bandwidth parameter obtained through measurement in an unassociated STA link metric response and transmits the unassociated STA link metric response to the controller node (the step S405). Consequently, the controller node obtains the bandwidth parameters of the backhaul STAs 25 of the agent nodes from the unassociated STA link metric responses (the step S407). The controller node also measures the bandwidth parameter of the backhaul STA 25 thereof every ten seconds in response to the unassociated STA link metric request so as to obtain the bandwidth parameter of the backhaul STA 25 of the controller node.

Next, the controller node transmits an IEEE 1905 link metric request to the agent nodes in accordance with the IEEE 1905 protocol (the step S409). Each of the agent nodes measures the communication quality parameter of the backhaul STA 25 thereof every one seconds in response to the IEEE 1905 link metric request (the step S411). Next, each of the agent nodes places the communication quality parameter obtained through measurement into an IEEE 1905 link metric response and transmits the IEEE 1905 link metric response to the controller node (the step S413). Consequently, the controller node obtains the communication quality parameters of the backhaul STAs 25 of the agent nodes from the IEEE 1905 link metric responses (the step S415). The controller node also measures the communication quality parameter of the backhaul STA 25 thereof every one seconds in response to the IEEE 1905 link metric request so as to obtain the communication quality parameter of the backhaul STA 25 of the controller node.

Continuing from the foregoing, the controller node transmits a channel selection request to the agent node in accordance with the operating channel regulations (the step S417). Each of the agent nodes performs a setting of the operating channel of the backhaul STA 25 thereof in response to the channel selection request and obtains the channel information and bandwidth parameter of the operating channel of the backhaul STA 25 thereof (the step S419). Next, each of the agent nodes places the channel information and bandwidth parameter in an operating channel response and transmits the operating channel response to the controller node (the step S421). Consequently, the controller node obtains the channel information and bandwidth parameters of the backhaul STAs 25 of the agent nodes from the operating channel responses (the step S423). The controller node also performs the setting of the operating channel of the backhaul STA 25 thereof in response to the channel selection request and obtains the channel information and bandwidth parameter of the operating channel of the backhaul STA 25 thereof. Next, the controller node stores the various parameters (such as the communication quality parameter, the bandwidth parameter, and the channel information) of the backhaul STA 25 of each of the network nodes 20A-20C in the storage circuit 23 of the controller node (the step S425) for being used in subsequent steps.

Please refer to FIG. 3 again. After the communication quality parameter and the bandwidth parameter of each of the network nodes 20A-20C have been obtained, or after the communication quality parameter, the bandwidth parameter, and channel information of each of the network nodes 20A-20C have been obtained, the controller node obtains the topological connection relationship of the network nodes 20A-20C in the mesh topology (such as shown by the solid lines among the network nodes 20A-20C in FIG. 1) (the step S303). For example, in an exemplary embodiment, the controller node uses existing network topology probing methods in accordance with beacon metrics regulations and the unassociated STA link metrics regulations in the IEEE 1905 protocol and the Wi-Fi EasyMesh protocol. As a result, the controller node establishes the logical topology relationship among the network nodes 20A-20C as the topological connection relationship of the network nodes 20A-20C in the mesh topology. Besides, the controller node stores the logical topology relationship in the storage circuit 23 of the controller node for being used in subsequent steps. It is noted that, although the logical topology relationship established by the controller node may not necessarily precisely present the actual internet topology relationship of the wireless network 10, such logical topology relationship can be used to approximately represent a general connection relationship among the network nodes 20A-20C. In another exemplary embodiment, a manager or an establisher of the wireless network 10 may input actual network topology information of the network nodes 20A-20C in the mesh topology to the controller node. As a result, the controller node can directly obtain the topological connection relationship of the network nodes 20A-20C in the mesh topology from the actual network topology information.

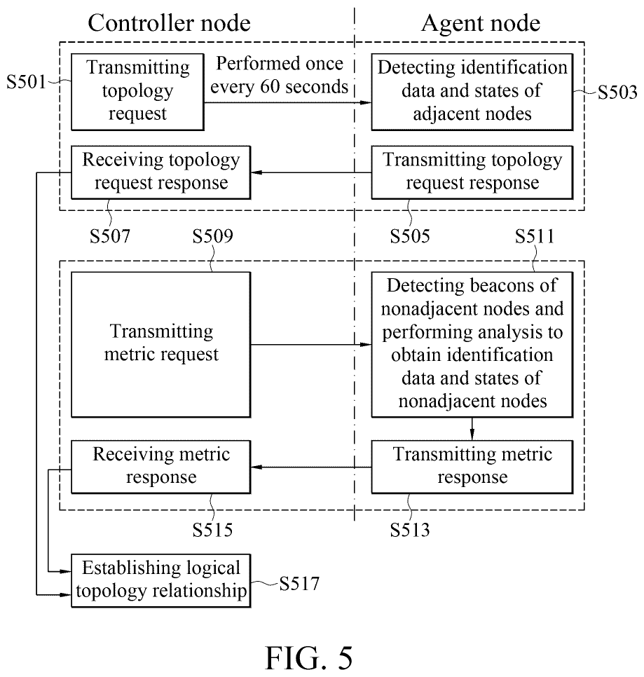

Please refer to FIG. 5. FIG. 5 illustrates a flow chart of the controller node establishing the logical topology relationship according to some embodiments of the instant disclosure. In FIG. 5, steps which are in columns assigned to a specific device are the steps performed by the specific device. For example, portions which are denoted in the “controller node” columns are the steps performed by the controller node; and portions which are denoted in the “agent node” columns are the steps performed by the agent node.

For example, as shown in FIG. 5, the controller node transmits a topology request to the agent nodes in accordance with the IEEE 1905 protocol (the step S501). Each of the agent nodes detects identification data (such as media access control addresses and hardware identification codes) and states of adjacent nodes thereof every 60 seconds in response to the topology request (the step S503). Next, each of the agent nodes places the identification data obtained through detection in a topology request response and transmits the topology request response to the controller node (the step S505). Consequently, the controller node obtains the identification data and the states of the adjacent nodes of the agent nodes from the topology request responses (the step S507). The controller node also detects the identification data and the states of the adjacent nodes thereof every 60 seconds in response to the topology request so as to obtain the identification data and the states of the adjacent nodes of the controller node. As shown in FIG. 5, the controller node transmits a metric request to the agent nodes in accordance with beacon metric regulations and the unassociated STA link metric regulations (the step S509). Each of the agent nodes detects beacons of nonadjacent nodes thereof and performs analysis in response to the metric request so as to obtain the identification data (such the media access control addresses and the hardware identification codes) and the states of nonadjacent nodes of the agent nodes (the step S511). Next, each of the agent nodes places the identification data and the states obtained through detection in a metric response and transmits the metric response to the controller node (the step S513). Consequently, the controller node obtains the identification data and the states of the nonadjacent nodes of the agent nodes from the metric responses (the step S515). The controller node also detects beacons of nonadjacent nodes thereof and performs analysis in response to the metric request so as to obtain the identification data and the states of nonadjacent nodes of the controller node. Next, the controller node establishes the logical topology relationship among the network nodes 20A-20C in accordance with the identification data and the states of the adjacent nodes thereof and the nonadjacent nodes thereof detected by the network nodes 20A-20C and by using existing network topology computation methods (the step S517).

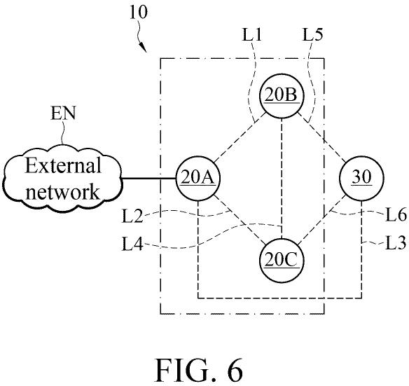

Please refer to FIG. 3 and FIG. 6. FIG. 6 illustrates a schematic structural diagram of the wireless network 10 according to some embodiments of the instant disclosure. After the topological connection relationship is obtained, the controller node obtains connection quality parameters of connections L1-L6 between each of the network nodes 20A-20C and the adjacent network nodes thereof in the topological connection relationship and the connection quality parameters of the connections L1-L6 between each of the network nodes 20A-20C and the idle node 30 in accordance with the communication quality parameters and the bandwidth parameters of the network nodes 20A-20C and a connection quality look-up table (described later) (the step S305). Specifically, in some embodiments, the controller node can obtain the communication quality parameters and the bandwidth parameters which correspond to the connections L1-L6 between each of the network nodes 20A-20C and the adjacent network nodes thereof in the topological connection relationship and the communication quality parameters and the bandwidth parameters which correspond to the connections L1-L6 between each of the network nodes 20A-20C and the idle node 30 in accordance with the communication quality parameters and the bandwidth parameters of the network nodes 20A-20C. Besides, the controller node can obtain the connection quality parameters of the connections L1-L6 in accordance with the communication quality parameters and the bandwidth parameters which correspond to the connections L1-L6 and the connection quality look-up table. As shown in FIG. 6, the connections L1, L2, L4 are the connections between each of the network nodes 20A-20C and adjacent network nodes 20A-20C thereof in the topological connection relationship. Specifically, in some embodiments, the connection L1 is the connection between the network node 20A and the network node 20B, the connection L2 is the connection between the network node 20A and the network node 20C, and the connection L4 is the connection between the network node 20B and the network node 20C. The connections L3, L5, L6 are the connections which may be formed between each of the network nodes 20A-20C and the idle nodes 30 in the mesh topology of the wireless network 10. Specifically, in some embodiments, the connection L3 is the connection which may be formed between the network node 20A and the idle node 30 when the idle node 30 is joined to the mesh topology of the wireless network 10, the connection L5 is the connection which may be formed between the network node 20B and the idle node 30 when the idle node 30 is joined to the mesh topology of the wireless network 10, and the connection L6 is the connection which may be formed between the network node 20C and the idle node 30 when the idle node 30 is joined to the mesh topology of the wireless network 10.

Continuing from the foregoing, the controller node obtains a plurality of candidate paths of the idle node 30 in the mesh topology of the wireless network 10 in accordance with the topological connection relationship (the step S307). The candidate paths are formed by connecting different combinations of the network nodes 20A-20C with the idle node 30. The candidate paths refer to the paths formed by the network nodes through which data may be transmitted from the external network EN to the idle node 30. For example, as shown in FIG. 6, five candidate paths for the idle node 30 exist in the mesh topology of the wireless network 10. It is noted that, although five candidate paths are illustrated in FIG. 6, the instant disclosure is not limited thereto, and the number of the candidate paths may be adjusted in accordance with the number of the network nodes and the topological connection relationship. A first candidate path is formed by the connection L3, i.e., in the first candidate path, data is transmitted between the external network EN and the idle node 30 through the connection L3. In other words, in this embodiment, in the first candidate path, the external network EN forwards data to the idle node 30 through the network node 20A (and the idle node 30 forwards data to the external network EN through the network node 20A). A second candidate path is formed by the connection L1 and the connection L5, i.e., in the second candidate path, data is transmitted between the external network EN and the idle node 30 through the connection L1 and the connection L5. In other words, in this embodiment, in the second candidate path, the external network EN forwards data to the idle node 30 through the network node 20A and the network node 20B (and the idle node 30 forwards data to the external network EN through the network node 20B and the network node 20A). A third candidate path is formed by the connection L2 and the connection L6, i.e., in the third candidate path, data is transmitted between the external network EN and the idle node 30 through the connection L2 and the connection L6. In other words, in this embodiment, in the third candidate path, the external network EN forwards data to the idle node 30 through the network node 20A and the network node 20C (and the idle node 30 forwards data to the external network EN through the network node 20C and the network node 20A). A fourth candidate path is formed by the connection L1, the connection L4, and the connection L6, i.e., in the fourth candidate path, data is transmitted between the external network EN and the idle node 30 through the connection L1, the connection L4, and the connection L6. In other words, in this embodiment, in the fourth candidate path, the external network EN forwards data to the idle node 30 through the network node 20A, the network node 20B, and the network node 20C (and the idle node 30 forwards data to the external network EN through the network node 20C, the network node 20B, and the network node 20A). A fifth candidate path is formed by the connection L2, the connection L4, and the connection L5, i.e., in the fifth candidate path, data is transmitted between the external network EN and the idle node 30 through the connection L2, the connection L4, and the connection L5. In other words, in this embodiment, in the fifth candidate path, the external network EN forwards data to the idle node 30 through the network node 20A, the network node 20C, and the network node 20B (and the idle node 30 forwards data to the external network EN through the network node 20B, the network node 20C, and the network node 20A).

Next, the controller node calculates a path quality parameter of each of the candidate paths in accordance with the connection quality parameter of each of the connections in each of the candidate paths (the step S309). For example, the controller node sums up the connection quality parameters of the connections in each of the candidate paths. Besides, the controller node takes the summation of the connection quality parameters of the connections in each of the candidate paths as the path quality parameter of each of the candidate paths. Specifically, as shown in FIG. 6, in some embodiments, the path quality parameter of the first candidate path may be the connection quality parameter of the connection L3, the path quality parameter of the second candidate path may be the summation of the connection quality parameters of the connection L1 and the connection L5, the path quality parameter of the third candidate path may be the summation of the connection quality parameters of the connection L2 and the connection L6, the path quality parameter of the fourth candidate path may be the summation of the connection quality parameters of the connection L1, the connection L4, and the connection L6, and the path quality parameter of the fifth candidate path may be the summation of the connection quality parameters of the connection L2, the connection L4, and the connection L5.

Next, the controller node selects one of the candidate paths which has the optimum one of the path quality parameters (i.e., the candidate path which correspondingly has the optimum data transmission rate) from the candidate paths as a networking path for the idle node 30 to join the mesh topology of the wireless network 10 (the step S311). For example, assuming that the path quality parameter of each of the candidate paths is the summation of the connection quality parameters of the connections in each of the candidate paths, under this condition, the candidate path which has the largest path quality parameter will correspondingly have the optimum data transmission rate. As a result, the controller node takes the candidate path which has the largest path quality parameter as the networking path for the idle node 30 to join the mesh topology of the wireless network 10. Specifically, in some embodiments, the controller node places the identification data (such as the media access control addresses and the hardware identification codes) of relevant network nodes in the candidate path having the largest path quality parameter in an operation request. Besides, the controller node transmits the operation request to the idle node 30. The idle node 30 learns the networking path thereof (i.e., the candidate path which has the largest path quality parameter in the operation request) and the identification data of the relevant network nodes in the networking path in accordance with the operation request. Besides, the idle node 30 transmits a connection request to the network nodes to which the idle node 30 should be connected in the networking path thereof (such as the network node which is the furthest from the root node in the networking path). After the network node which receives the connection request authorizes the connection request of the idle node 30, the idle node 30 has been successfully joined to the wireless network 10 and thus become one of the network nodes in the wireless network 10. Consequently, after the idle node 30 is joined to the wireless network 10, data transmission between the external network EN and the idle node 30 is performed through the networking path. As a result, an optimum transmission performance of data transmission between the idle node 30 and the external network EN can be ensured, and therefore the optimum state of overall performance of the wireless network 10 can be ensured.

In a comparative embodiment, if the connection quality parameter of each of the connections in each of the candidate paths merely takes into consideration the communication quality parameter, then the path quality parameter of each of the candidate paths may be inaccurate. Furthermore, the selected candidate path which has the optimum path quality parameter may not correspondingly have the optimum data transmission rate. For example, under some conditions, the data transmission rate of a connection having a better communication quality parameter and a worse bandwidth parameter may be worse than the data transmission rate of a connection having a worse communication quality parameter and a better bandwidth parameter. Therefore, if the connection quality parameter of a connection merely takes into consideration the communication quality parameter, the connection quality of a connection having a worse data transmission rate may be concluded to be better than the connection quality of a connection having a better data transmission rate. Consequently, the path quality parameter of the candidate path having the worse data transmission rate may be concluded to be better than the path quality parameter of the candidate path having the better data transmission rate. As a result, the candidate path which is selected and has the optimum path quality parameter may not correspondingly have the optimum data transmission rate. In order to resolve the foregoing issues, in some embodiments of the instant disclosure, the connection quality parameter of each of the connections of each of the candidate paths takes into consideration the communication quality parameter and the bandwidth parameter. Thus, the path quality parameter of each of the candidate paths is accurate, and the candidate path which is selected and has the optimum path quality parameter can indeed correspondingly have the optimum data transmission rate. In this embodiment, the foregoing “better” may refer to larger, the foregoing “worse” may refer to smaller, and the foregoing “optimum” may be the largest.

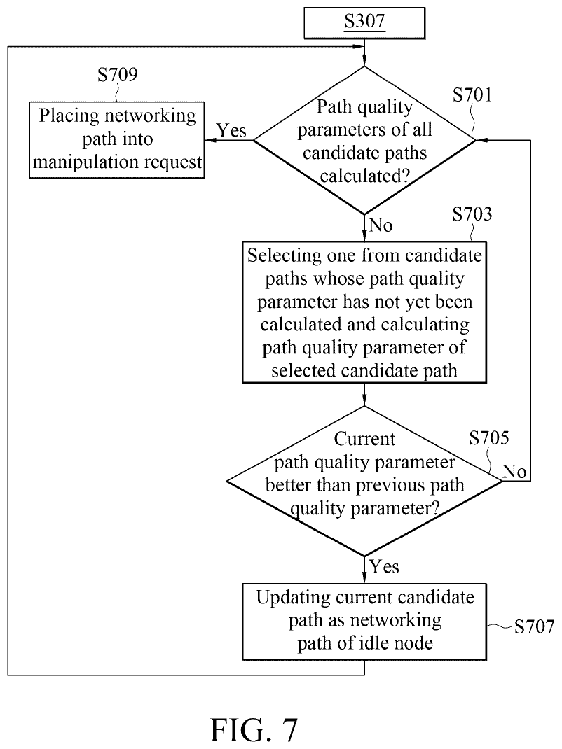

Please refer to FIG. 7. FIG. 7 illustrates a flow chart of calculating the path quality parameter of each of the candidate paths and selecting the networking path according to some embodiments of the instant disclosure. In some embodiments, after the candidate paths of the idle node 30 in the mesh topology of the wireless network 10 are obtained, the controller node determines whether the path quality parameters of all of the candidate paths have been calculated (the step S701). In this embodiment, if the path quality parameters of some candidate paths have not been calculated, the controller node selects one of the candidate paths whose path quality parameters have not been calculated and calculates the path quality parameter of the selected candidate path (the step S703). Next, the controller node determines whether the calculation result of the path quality parameter of the currently selected candidate path (referred to as a current path quality parameter hereinafter) is better than the calculation result of the path quality parameter of a previously selected candidate path (referred to as a previous path quality parameter) (the step S705). For example, the controller node determines whether the current path quality parameter is larger than the previous path quality parameter. If the current path quality parameter is better than (such as larger than) the previous path quality parameter, then the controller node updates the currently selected candidate path as the networking path of the idle node 30 (the step S707). Next, the controller node returns to the step S701 to continue determining whether the path quality parameters of all of the candidate paths have been calculated. If the current path quality parameter is not better than (such as not larger than) the previous path quality parameter, then the controller node also returns to the step S701 to continue determining whether the path quality parameters of all of the candidate paths have been calculated. If the path quality parameters of some of the candidate paths still have not been calculated, the step S703 and subsequent steps thereof will be executed. If the path quality parameters of all of the candidate paths have been calculated, the controller node places the networking path into the operation request (the step S709) and transmits the operation request to the idle node 30. As a result, the idle node 30 is joined to the mesh topology of the wireless network 10 in accordance to the operation request.

In some embodiments, the controller node further normalizes the communication quality parameter of each of the network nodes 20A-20C. Therefore, the controller node can obtain the connection quality parameter of the connection L1-L6 between each of the network nodes 20A-20C and the adjacent network nodes thereof in the topological connection relationship and the connection quality parameter of the connection L1-L6 between each of the network nodes 20A-20C and the idle node 30 in accordance with the communication quality parameters which have been normalized, the bandwidth parameter of each of the network nodes 20A-20C, and the connection quality look-up table. In other words, in some embodiments, the controller node normalizes the communication quality parameter which corresponds to each of the connections L1-L6. Besides, the controller node obtains the connection quality parameters of each of the connections L1-L6 in accordance to the connection quality look-up table, the bandwidth parameter corresponding to each of the connections L1-L6, and the communication quality parameter corresponding to each of the connections L1-L6 and has been normalized. For example, the controller node may add a normalization value (such as 100) to the communication quality parameter corresponding to each of the connections L1-L6 so as to generate the communication quality parameters which have been normalized.

In some embodiments, the storage circuit 32 of the controller node stores a first communication quality threshold value, a second communication quality threshold value, connection quality references, and a bandwidth reference so as to assist in the calculation of the connection quality parameter of each of the connections L1-L6. The second communication quality threshold value is larger than the first communication quality threshold value. In some embodiments, the controller node divides three communication quality ranges in accordance with the first communication quality threshold value and the second communication quality threshold value. The connection quality references correspond to the three communication quality ranges and the bandwidth reference. In some embodiments, the controller node integrates the three communication quality ranges, the bandwidth reference, the connection quality references, and a correspondence relationship among the foregoing data into the connection quality look-up table. Besides, the controller node stores the connection quality look-up table in the storage circuit 23. In some embodiments, the controller node merely needs to store a small number of references and threshold values (such as the first communication quality threshold value, the second communication quality threshold value, the connection quality references, and the bandwidth reference) or needs to store the connection quality look-up table which is indirectly formed by the foregoing small number of references and threshold values to be able to calculate the connection quality parameter of each of the connections L1-L6. As a result, a storage burden of the controller node can be reduced.

In some embodiments, the step of obtaining the connection quality parameter of the connection further comprises that the controller node selects one from the three connection quality references in response to the relationship between the communication quality parameter corresponding to the connection and the three communication quality ranges, and the controller node calculates the connection quality parameter of the connection according to the selected connection quality reference and a ratio of the bandwidth parameter corresponding to the connection to the bandwidth reference. In some embodiments, the ratio of the bandwidth parameter corresponding to the connection to the bandwidth reference is multiplied by the selected connection quality reference to obtain the connection quality parameter of the connection.

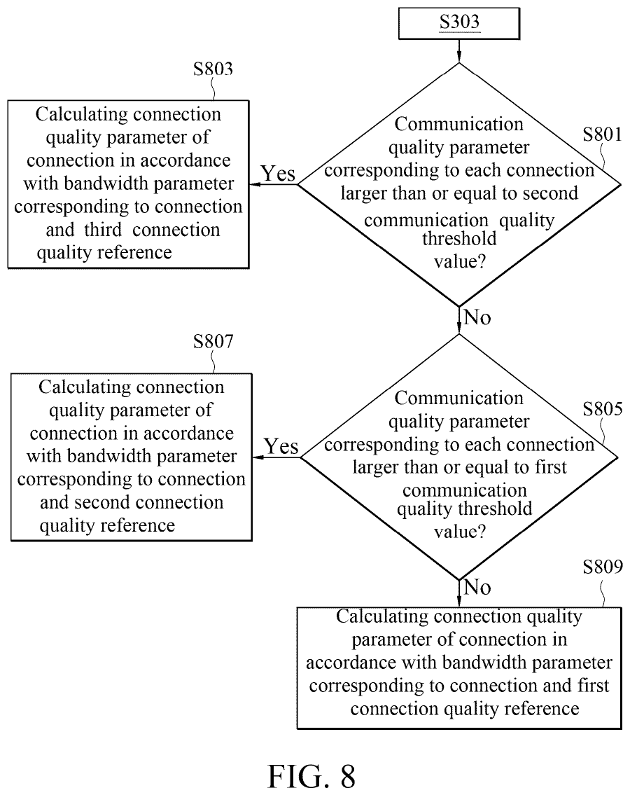

Please refer to FIG. 8. FIG. 8 illustrates a flow chart of calculating the connection quality parameter of each of the connections L1-L6 between each of the network nodes 20A-20C and the adjacent network nodes thereof in the topological connection relationship and between each of the network nodes 20A-20C and the idle node 30 according to some embodiments of the instant disclosure. The following description will be illustrated with a scenario where the connection quality look-up table includes a bandwidth reference and three connection quality references. The three connection quality references correspond to the three communication quality ranges, respectively. For example, as shown in Table 1, a first one of the three connection quality references (referred to as a first connection quality reference hereinafter) corresponds to a first one of the three communication quality ranges (referred to as a first communication quality range hereinafter), a second one of the three connection quality references (referred to as a second connection quality reference hereinafter) corresponds to a second one of the three communication quality ranges (referred to as a second communication quality range hereinafter), and a third one of the three connection quality references (referred to as a third connection quality reference hereinafter) corresponds to a third one of the three communication quality ranges (referred to as a third communication quality range hereinafter). The second connection quality reference is larger than the first connection quality reference, and the third connection quality reference is larger than the second connection quality reference. The third communication quality range is a communication quality range which is larger than or equal to the second communication quality threshold value, the second communication quality range is a communication quality range which is between the second communication quality threshold value and the first communication quality threshold value, and the first communication quality range is a communication quality range which is smaller than the first communication quality threshold value.

TABLE 1
First embodiment of connection quality look-up table

| | Third | Second | First |
|---|---|---|---|
| Bandwidth | communication | communication | communication |
| reference | quality range | quality range | quality range |
| 20 MHz | 7 (third | 4 (second | 1 (first |
| | connection | connection | connection |
| | quality | quality | quality |
| | reference) | reference) | reference) |

As shown in FIG. 8, in some embodiments of the step S305, the controller node determines whether the communication quality parameter corresponding to each of the connections L1-L6 is larger than or equal to the second communication quality threshold value (the step S801). In response to that the communication quality parameter corresponding to one of the connections L1-L6 is larger than or equal to the second communication quality threshold value, the controller node determines that the foregoing communication quality parameter is in the third communication quality range and looks up the connection quality look-up table so as to obtain the third connection quality reference. For such connections L1-L6, the controller node calculates a ratio of the bandwidth parameter corresponding to each of the connections L1-L6 to the bandwidth reference in accordance with the bandwidth parameters corresponding to each of the connections L1-L6 and the bandwidth reference in the connection quality look-up table. For example, the controller node divides the bandwidth parameter corresponding to each of the connections L1-L6 by the bandwidth reference in the connection quality look-up table to calculate the ratio of the bandwidth parameter corresponding to each of the connections L1-L6 to the bandwidth reference. The controller node calculates the connection quality parameter of each of the connections L1-L6 in accordance with the ratio of the bandwidth parameter corresponding to each of the connections L1-L6 to the bandwidth reference and the third connection quality reference (the step S803). For example, the controller node takes a product of the ratio of the bandwidth parameter corresponding to each of the connections L1-L6 to the bandwidth reference and the third connection quality reference (i.e., a value obtained by multiplying the ratio of the bandwidth parameter corresponding to each of the connections L1-L6 to the bandwidth reference by the third connection quality reference) as the connection quality parameter of each of the connections L1-L6.

If the communication quality parameter corresponding to one of the connections L1-L6 is smaller than the second communication quality threshold value, the controller node determines whether the foregoing communication quality parameter is larger than or equal to the first communication quality threshold value (the step S805). In response to that the foregoing communication quality parameter is larger than or equal to the first communication quality threshold value, the controller node determines that the foregoing communication quality parameter is between the first communication quality threshold value and the second communication quality threshold value (i.e., the controller node determines that the foregoing communication quality parameter is in the second communication quality range) and looks up the connection quality look-up table so as to obtain the second connection quality reference. For such connections L1-L6, the controller node calculates the connection quality parameter of each of the connections L1-L6 in accordance with the ratio of the bandwidth parameter corresponding to each of the connections L1-L6 to the bandwidth reference and the second connection quality reference (the step S807). For example, the controller node takes the product of the ratio of the bandwidth parameter corresponding to each of the connections L1-L6 to the bandwidth reference and the second connection quality reference (i.e., a value obtained by multiplying the ratio of the bandwidth parameter corresponding to each of the connections L1-L6 to the bandwidth reference by the second connection quality reference) as the connection quality parameter of each of the connections L1-L6.

If the communication quality parameter corresponding to one of the connections L1-L6 is smaller than the first communication quality threshold value, the controller node determines that the foregoing communication quality parameter is in the first communication quality range and looks up the connection quality look-up table so as to obtain the first connection quality reference. For such connections L1-L6, the controller node calculates the connection quality parameter of each of the connections L1-L6 in accordance with the ratio of the bandwidth parameter corresponding to each of the connections L1-L6 to the bandwidth reference and the first connection quality reference (the step S809). For example, the controller node takes the product of the ratio of the bandwidth parameter corresponding to each of the connections L1-L6 to the bandwidth reference and the first connection quality reference (i.e., a value obtained by multiplying the ratio of the bandwidth parameter corresponding to each of the connections L1-L6 to the bandwidth reference by the first connection quality reference) as the connection quality parameter of each of the connections L1-L6. The data transmission rate of each of the connections L1-L6 is proportional to the bandwidth of each of the connections L1-L6. Consequently, by applying the ratio of the bandwidth parameter corresponding to each of the connections L1 -L6 to the bandwidth reference, under the condition of reduced storage burden of the controller node (such as merely one bandwidth reference needs to be stored, i.e., the connection quality look-up table merely needs to include one bandwidth reference), the connection quality parameters which are calculated in the case that different connections correspond to the same communication quality range and different bandwidth parameters are proportional to each other and proportional to the data transmission rates.

As shown in FIG. 6 and Table 1, in an exemplary embodiment, the second communication quality threshold value is 50 dBm, the first communication quality threshold value is 33 dBm, the first connection quality reference is 1, the second connection quality reference is 4, the third connection quality reference is 7, and the bandwidth reference is 20 MHz. The communication quality parameter corresponding to the connection L1 is −50 dBm before normalization and 50 dBm after normalization; the communication quality parameter corresponding to the connection L2 is −44 dBm before normalization and 56 dBm after normalization; the communication quality parameter corresponding to the connection L3 is −67 dBm before normalization and 33 dBm after normalization; the communication quality parameter corresponding to the connection L4 is −56 dBm before normalization and 44 dBm after normalization; the communication quality parameter corresponding to the connection L5 is −50 dBm before normalization and 50 dBm after normalization; and the communication quality parameter corresponding to the connection L6 is −66 dBm before normalization and 34 dBm after normalization. The bandwidth parameter corresponding to the connection L1 is 80 MHz; the bandwidth parameter corresponding to the connection L2 is 40 MHz; the bandwidth parameter corresponding to the connection L3 is 40 MHz; the bandwidth parameter corresponding to the connection L4 is 40 MHz, the bandwidth parameter corresponding to the connection L5 is 40 MHz; and the bandwidth parameter corresponding to the connection L6 is 40 MHz. In this embodiment, based on the communication quality parameters after normalization, the connection quality parameter of the connection L1 is calculated to be 28, the connection quality parameter of the connection L2 is calculated to be 14, the connection quality parameter of the connection L3 is calculated to be 8, the connection quality parameter of the connection L4 is calculated to be 8, the connection quality parameter of the connection L5 is calculated to be 14, and the connection quality parameter of the connection L6 is calculated to be 8.

The following description will be illustrated with a scenario where the connection quality look-up table includes a plurality of bandwidth references and a plurality of (more than three) connection quality references.

In some embodiments of the step S305, the controller node selects corresponding values from the bandwidth references and the three communication quality ranges in the connection quality look-up table in accordance with the communication quality parameter and the bandwidth parameter which correspond to each of the connections L1-L6. Besides, the controller node takes the connection quality references corresponding to the selected ones of the bandwidth references and the selected ones of the communication quality ranges as the connection quality parameters of the connections L1-L6. Specifically, as shown in Table 2, in some embodiments, the connection quality look-up table defines (i.e., in this embodiment, records) a variety of bandwidth references, the three communication quality ranges divided by the first communication quality threshold value and the second communication quality threshold value (i.e., the first communication quality range, the second communication quality range, and the third communication quality range), the connection quality references corresponding to the bandwidth references under the first communication quality range, the connection quality references corresponding to the bandwidth references under the second communication quality range, and the connection quality references corresponding to the bandwidth references under the third communication quality range. Therefore, the controller node looks up the communication quality range in which the communication quality parameter falls in the connection quality look-up table in accordance with the communication quality parameter and the bandwidth parameter which correspond to each of the connections L1-L6. Besides, the controller node looks up the bandwidth reference which conforms to each of the bandwidth parameters in the connection quality look-up table. Therefore, the controller node can obtain the connection quality references corresponding to the communication quality ranges and the bandwidth reference which have been looked up as the connection quality parameters of the connections L1-L6. In this embodiment, the determination of the communication quality ranges in which the communication quality parameters fall may be the step S801 and the step S805 and will not be repeatedly illustrated.

TABLE 2
Second embodiment of connection quality look-up table

| | | Third | Second | First |
|---|---|---|---|---|
| Bandwidth | | communication | communication | communication |
| reference | | quality range | quality range | quality range |
| 20 | MHz | 7 (connection quality | 4 (connection quality | 1 (connection quality |
| | | reference) | reference) | reference) |
| 40 | MHz | 14 (connection | 8 (connection quality | 2 (connection quality |
| | | quality reference) | reference) | reference) |
| 80 | MHz | 28 (connection | 16 (connection quality | 4 (connection quality |
| | | quality reference) | reference) | reference) |
| 160 | MHz | 56 (connection | 32 (connection quality | 8 (connection quality |
| | | quality reference) | reference) | reference) |

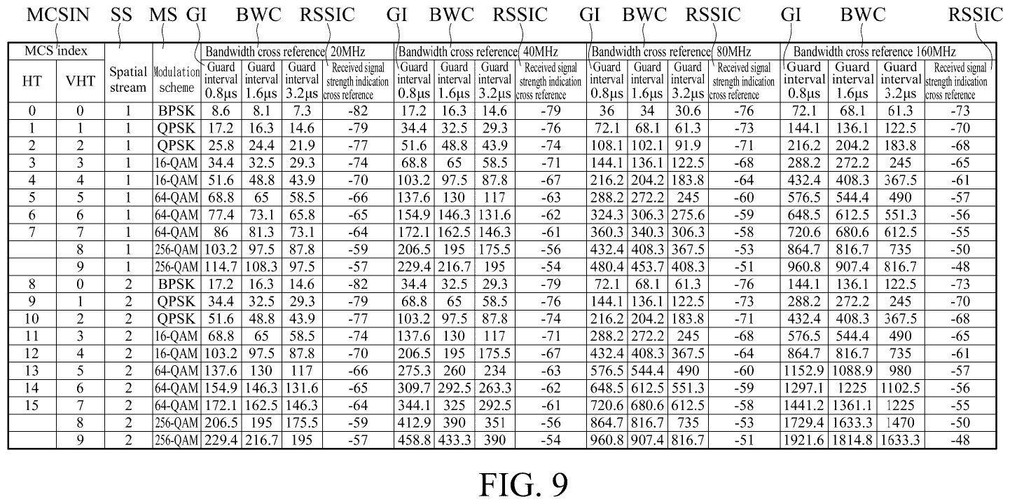

Please refer to FIG. 9. FIG. 9 illustrates a schematic diagram of a modulation and coding scheme index cross reference table of a standard protocol according to a comparative embodiment of the instant disclosure. In this comparative embodiment, if the connection quality parameter (such as a modulation and coding scheme index MSCIN) of each of the connections in each of the candidate paths is looked up through the modulation and coding scheme index cross reference table, more storage resources and computation resources of the controller node have to be consumed. For example, the modulation and coding scheme index cross reference table may define (i.e., in this embodiment, record) a plurality of modulation and coding scheme indexes MSCIN. The modulation and coding scheme indexes MSCIN correspond to different network protocols (such as an IEEE 802.11n protocol, an IEEE 802.11ac protocol, where the IEEE 802.11n protocol is denoted with “HT” in FIG. 9, and the IEEE 802.11ac protocol is denoted with “VHT” in FIG. 9), different bandwidth cross references BWC, different received signal strength indication cross references RSSIC, different spatial streams SS, different modulation schemes MS, different guard intervals GI, and so on. As a result, when looking up the connection quality parameter of each of the connections in each of the candidate paths, the network protocol, the bandwidth cross reference BWC, the received signal strength indication cross reference RSSIC, the spatial stream SS, the modulation scheme MS, and the guard interval GI have to be compared one by one in order to look up the connection quality parameter (i.e., the modulation and coding scheme index MSCIN) of each of the connections in each of the candidate paths. In other words, it is understood that the modulation and coding scheme index cross reference table of the IEEE 802.11ac protocol is complex and consumes more storage resources and computation resources of the controller node. In order to resolve such issue, one or some embodiments of the instant disclosure simplify the schematic diagram of the modulation and coding scheme index cross reference table of the IEEE 802.11ac protocol through an approximate modulation and coding scheme index calculation table (i.e., in this embodiment, the connection quality look-up table). For example, the connection quality parameters of the connection quality look-up table merely have to correspond to the bandwidth references, and the three communication quality ranges are divided by the first communication quality threshold value and the second communication quality threshold value. Therefore, the storage resources and computation resources of the controller node can be reduced.

In one or some embodiments of the instant disclosure, the modulation and coding scheme index cross reference table of a standard protocol is replaced with the approximate modulation and coding scheme index calculation table (i.e., in this embodiment, the connection quality look-up table). It should be understood that the approximate modulation and coding scheme index calculation table (i.e., in this embodiment, the connection quality look-up table) in one or some embodiments of the instant disclosure merely takes into consideration the communication quality parameters (such as the received signal strength indication) and the three communication quality ranges of the bandwidth parameters and the bandwidth references of the bandwidth parameters. Consequently, according to one or some embodiments of the instant disclosure, the following parameters of the modulation and coding scheme index cross reference table of a standard protocol are no longer needed to be taken into consideration: the received signal strength indication cross reference RSSIC, the network protocol, the spatial stream SS, the modulation scheme MS, and the guard interval GI.

In some embodiments, the controller node can learn a channel at which each of the connections L1-L6 between each of the network nodes 20A-20C and the adjacent network nodes thereof is in the topological connection relationship and at which each of the connections L1-L6 between each of the network nodes 20A-20C and the idle node 30 is in the topological connection relationship in accordance with the channel information of the network nodes 20A-20C. The controller node stores the channel parameters in the storage circuit 23. The channel parameters include a plurality of channel parameters corresponding to different channels. As shown in Equation 1, where α_{5G_first} is the channel parameter, a is the channel parameter value corresponding to a 5G channel. The controller node looks up the channel parameters in accordance with the channels at which the connections L1-L6 are so as to obtain the channel parameter values corresponding to the channels at which the connections L1-L6 are. In some embodiments, channel parameter values corresponding to different channels may have different values, so that an influence on the transmission performance (such as the data transmission rates) of the connections L1-L6 brought about by different channels can be taken into consideration (described later). For example, as shown in Equation 1, the channel parameter value corresponding to the 5G channel may be 1.5 and greater than the channel parameter value corresponding to the 2.4G channel (which is 1). As a result, the transmission performance of the 5G channel is better than the transmission performance of the 2.4G channel. Consequently, the connection quality parameter of a connection in the 5G channel may be concluded to be better (such as larger) than the connection quality parameter of a connection in the 2.4G channel. In some other embodiments, if the influence on the transmission performance (such as the data transmission rates) of the connections L1-L6 brought about by different channels is not taken into consideration, then the channel parameter values corresponding to different channels may have the same value. For example, as shown in Equation 1, the channel parameter value a corresponding to the 5G channel may be 1 and identical to the channel parameter value a (which is 1) corresponding to the 2.4G channel, and therefore the difference between the transmission performances of the 5G channel and the 2.4G channel is not taken into consideration.

$${α}_{5 G\_first} = \{ \begin{matrix}α for 5 G \\ 1 for 2.4 G\end{matrix} \qquad ( Equation 1 )$$

In some embodiments, the controller node further adjusts the connection quality references in the connection quality look-up table in accordance with the channel parameter value corresponding to the channel at which each of the connections L1-L6 is. For example, before the controller node looks up the connection quality look-up table in accordance with the communication quality parameter and the bandwidth parameter which correspond to each of the connections L1-L6, the controller node multiplies the channel parameter value corresponding to the channel at which each of the connections L1-L6 is by the connection quality reference in the connection quality look-up table so as to form new ones of the connection quality references in the connection quality look-up table. In other words, in some embodiments, as shown in Table 3 and Table 4, the controller node multiplies the connection quality reference in the connection quality look-up table by the channel parameter α_{5G_first} so as to form the new ones of the connection quality references in the connection quality look-up table. Therefore, the connection quality parameters of the connections L1-L6 which are looked up from the connection quality look-up table (which is constituted by the new ones of the connection quality references) can take into consideration the influence on the transmission performance of the connections L1-L6 brought about by different channels (such as by setting the channel parameter value corresponding to the 5G channel to be greater than the channel parameter value corresponding to the 2.4G channel). Furthermore, the optimum transmission performance of data transmission between the idle node 30 and the external network EN can be ensured, and therefore the optimum state of the overall performance of the wireless network 10 can be ensured.

TABLE 3
Third embodiment of connection quality look-up table

| | Third | Second | First |
|---|---|---|---|
| Bandwidth | communication | communication | communication |
| reference | quality range | quality range | quality range |
| 20 MHz | 7*α_{5G}_{_{—}}_{first} (third | 4*α_{5G}_{_{—}}_{first} (second | 1*α_{5G}_{_{—}}_{first} (first |
| | connection | connection | connection |
| | quality | quality | quality |
| | reference) | reference) | reference) |

TABLE 4
Fourth embodiment of connection quality look-up table

| | | Third | Second | First |
|---|---|---|---|---|
| Bandwidth | | communication | communication | communication |
| reference | | quality range | quality range | quality range |
| 20 | MHz | 7*α_{5G}_{_{—}}_{first} | 4*α_{5G}_{_{—}}_{first} | 1*α_{5G}_{_{—}}_{first} |
| | | (connection quality | (connection quality | (connection quality |
| | | reference) | reference) | reference) |
| 40 | MHz | 14*α_{5G}_{_{—}}_{first} | 8*α_{5G}_{_{—}}_{first} | 2*α_{5G}_{_{—}}_{first} |
| | | (connection quality | (connection quality | (connection quality |
| | | reference) | reference) | reference) |
| 80 | MHz | 28*α_{5G}_{_{—}}_{first} | 16*α_{5G}_{_{—}}_{first} | 4*α_{5G}_{_{—}}_{first} |
| | | (connection quality | (connection quality | (connection quality |
| | | reference) | reference) | reference) |
| 160 | MHz | 56*α_{5G}_{_{—}}_{first} | 32*α_{5G}_{_{—}}_{first} | 8*α_{5G}_{_{—}}_{first} |
| | | (connection quality | (connection quality | (connection quality |
| | | reference) | reference) | reference) |

In some embodiments of the step S309, the controller node calculates the path quality parameter of each of the candidate paths in accordance with Equation 2. In this embodiment, PDRTS denotes the path quality parameter of each of the candidate paths, link denotes each of the connections in each of the candidate paths, number of links denotes a total number of the connections in each of the candidate paths, and MCSₗᵢₙₖ denotes the connection quality parameter of each of the connections in each of the candidate paths. As shown in FIG. 6, in an exemplary embodiment, the path quality parameter of the first candidate path is calculated using Equation 3, the path quality parameter of the second candidate path is calculated using Equation 4, the path quality parameter of the third candidate path is calculated using Equation 5, the path quality parameter of the fourth candidate path is calculated using Equation 6, and the path quality parameter of the fifth candidate path is calculated using Equation 7. In Equation 3 through Equation 7, M₁ is the connection quality parameter of the connection L1 and is 28, M₂ is the connection quality parameter of the connection L2 and is 14, M₃ is the connection quality parameter of the connection L3 and is 8, M₄ is the connection quality parameter of the connection L4 and is 8, M₅ is the connection quality parameter of the connection L5 and is 14, and M₆ is the connection quality parameter of the connection L6 and is 8. Therefore, in this exemplary embodiment, because the path quality parameter of the second candidate path is the largest of the five candidate paths and therefore correspondingly has the optimum data transmission rate, the controller node selects the second candidate path as the networking path for the idle node 30 to be joined to the mesh topology of the wireless network 10.

$$PDRTS = \frac{1}{{\sum }_{l i n k}^{n u mber of links} \frac{1}{M C {S}_{l i n k}}} \qquad ( Equation 2 )$$

$$8. ≅ \frac{1}{\frac{1}{M 3}} \qquad ( Equation 3 )$$

$$9.3 ≅ \frac{1}{\frac{1}{M 1} + \frac{1}{M 5}} \qquad ( Equation 4 )$$

$$5.1 ≅ \frac{1}{\frac{1}{M 2} + \frac{1}{M 6}} \qquad ( Equation 5 )$$

$$3.5 ≅ \frac{1}{\frac{1}{M 1} + \frac{1}{M 4} + \frac{1}{M 6}} \qquad ( Equation 6 )$$

$$3.7 ≅ \frac{1}{\frac{1}{M 2} + \frac{1}{M 4} + \frac{1}{M 5}} \qquad ( Equation 7 )$$

In some embodiments of the step S309, the controller node calculates the path quality parameter of each of the candidate paths in accordance with the connection quality parameter of each of the connections in each of the candidate paths, a connection spacing number between each of the connections and the root node in each of the candidate paths, and a hop adjustment parameter. The connection spacing number refers to a number of connections spaced between a single connection and the root node in a candidate path. Specifically, in some embodiments, the connection spacing number refers to a value obtained by subtracting 1 from a hop number between a node which is further away from the root node and the root node, wherein the node which is further away from the root node and the root node are connected to two ends of a single connection. For example, as shown in FIG. 6, because the connections L1-L3 are the connection between the network node 20B and the network node 20A, the connection between the network node 20C and the network node 20A, and the connection between the idle node 30 and the network node 20A, respectively (i.e., the connections L1-L3 are directly connected to the root node), the number of connections spaced between each of the connections L1-L3 and the root node (i.e., the connection spacing number) is 0. In the second candidate path, the number of the connections spaced between the connection L5 and the root node (i.e., the connection spacing number) is 1. In the third candidate path, the number of the connections spaced between the connection L6 and the root node (i.e., the connection spacing number) is 1. In the fourth candidate path, the number of the connections spaced between the connection L4 and the root node (i.e., the connection spacing number) is 1, and the number of the connections spaced between the connection L6 and the root node (i.e., the connection spacing number) is 2. In the fifth candidate path, the number of the connections spaced between the connection L4 and the root node (i.e., the connection spacing number) is 1, and the number of the connections spaced between the connection L5 and the root node (i.e., the connection spacing number) is 2. The hop adjustment parameter is used to adjust the hop number which may be formed between the idle node 30 and the external network EN. By taking into consideration the connection pacing number and the hop adjustment number, the calculation of the path quality parameters of the candidate paths can allow the topology type of the mesh topology to lean toward being a linear topology or a star topology after the idle node 30 is joined to the mesh topology of the wireless network 10 through the networking path.

In some embodiments, a range of the hop adjustment parameter may be between −3 and 3. In response to that the controller node sets the hop adjustment parameter smaller, the topology type of the mesh topology can lean toward being the linear topology after the idle node 30 is joined to the mesh topology of the wireless network 10 through the networking path. In response to that the controller node sets the hop adjustment parameter greater, the topology type of the mesh topology can lean toward being the star topology after the idle node 30 is joined to the mesh topology of the wireless network 10 through the networking path.

In some embodiments of the step S309, the controller node calculates the path quality parameter of each of the candidate paths in accordance with Equation 8, where PDRTS denotes the path quality parameter of each of the candidate paths, i denotes the connection spacing number between each of the connections and the root node in each of the candidate paths, number of links denotes a total number of the connections in each of the candidate paths, MCSᵢ denotes the connection quality parameter of each of the connections in each of the candidate paths, and lessₕₒₚ denotes the hop adjustment parameter. As shown in FIG. 6, in an exemplary embodiment, the path quality parameter of the first candidate path is calculated using Equation 9, the path quality parameter of the second candidate path is calculated using Equation 10, the path quality parameter of the third candidate path is calculated using Equation 11, the path quality parameter of the fourth candidate path is calculated using Equation 12, and the path quality parameter of the fifth candidate path is calculated using Equation 13. In Equation 9 through Equation 13, M₁ is the connection quality parameter of the connection L1 and is 28, M₂ is the connection quality parameter of the connection L2 and is 14, M₃ is the connection quality parameter of the connection L3 and is 8, M₄ is the connection quality parameter of the connection L4 and is 8, M₅ is the connection quality parameter of the connection L5 and is 14, M₆ is the connection quality parameter of the connection L6 and is 8, and the hop adjustment parameter is 2. Therefore, in this exemplary embodiment, because the path quality parameter of the first candidate path is the largest of the five candidate paths, the controller node selects the first candidate path as the networking path for the idle node 30 to be joined to the mesh topology of the wireless network 10.

$$PDRTS = \frac{1}{{\sum }_{i = 0}^{n u mber of links} ( \frac{1}{M C {S}_{i}} + {less}_{h o p} * i * 0.01 )} \qquad ( Equation 8 )$$

$$8. ≅ \frac{1}{\frac{1}{M 3} + 2 * 0 * 0 \text{.01}} \qquad ( Equation 9 )$$

$$7.9 ≅ \frac{1}{( \frac{1}{M 1} + 2 * 0 * 0.01 ) + ( \frac{1}{M 5} + 2 * 1 * 0.01 )} \qquad ( Equation 10 )$$

$$4.6 ≅ \frac{1}{( \frac{1}{M 2} + 2 * 0 * 0.01 ) + ( \frac{1}{M 6} + 2 * 1 * 0.01 )} \qquad ( Equation 11 )$$

$$2.9 ≅ \frac{1}{( \frac{1}{M 1} + 2 * 0 * 0.01 ) + ( \frac{1}{M 4} + 2 * 1 * 0.01 ) + ( \frac{1}{M 6} + 2 * 2 * 0.01 )} \qquad ( Equation 12 )$$

$$3.1 ≅ \frac{1}{( \frac{1}{M 2} + 2 * 0 * 0.01 ) + ( \frac{1}{M 4} + 2 * 1 * 0.01 ) + ( \frac{1}{M 5} + 2 * 2 * 0.01 )} \qquad ( Equation 13 )$$

As above, according to some embodiments of the instant disclosure, through taking into consideration the communication quality parameter and the bandwidth parameter which correspond to each of the connection in each of the candidate paths, a candidate path having the optimum transmission performance (such as having the optimum path quality parameter) can be selected from the candidate paths as the networking path for the idle node to be joined to the mesh topology of the wireless network, and therefore the overall performance of the wireless network can be improved. In some embodiments of the instant disclosure, through further taking into consideration the channel parameter value corresponding to the channel at which each of the connections in each of the candidate paths is, the candidate path having the optimum transmission performance (such as having the optimum path quality parameter) can be even more accurately selected from the candidate paths as the networking path for the idle node to be joined to the mesh topology of the wireless network, and therefore the overall performance of the wireless network can be further improved.

In some embodiments, the controller node merely needs to store a small number of references and threshold values (such as the first communication quality threshold value, the second communication quality threshold value, the connection quality references, and the bandwidth reference) or needs to store the connection quality look-up table which is indirectly formed by the foregoing small number of references and threshold values to be able to calculate the connection quality parameter of each of the connections. As a result, the storage burden of the controller node can be reduced.

In some embodiments, compared with using the modulation and coding scheme index cross reference table to look up the connection quality parameter (such as the MCS index) of each of the connections in each of the candidate paths, the connection quality parameter of each of the connections in each of the candidate paths is calculated or looked up through the small number of references and threshold values stored by the controller node (such as the first communication quality threshold value, the second communication quality threshold value, the connection quality reference, and the bandwidth reference) or the connection quality look-up table which is stored by the controller node and indirectly formed by the small number of references and threshold values. As a result, computation time and look-up time of the controller node can be reduced, and thus a consumption of computation resources of the controller node can be reduced.

According to some embodiments of the instant disclosure, the path quality parameter of each of the candidate paths can be adjusted through the connection spacing number between each of the connections and the root node in each of the candidate paths and the hop adjustment parameter. As a result, after the idle node is joined to the mesh topology of the wireless network, the topological type of the mesh topology can lean toward being the linear topology or the star topology.

What is claimed is:

1. A method for backhaul networking, applicable to a wireless network comprising a plurality of network nodes which are interconnected to form a mesh topology, the method comprising:
obtaining a communication quality parameter and a bandwidth parameter of each of the network nodes;
obtaining a topological connection relationship of the network nodes in the mesh topology;
obtaining a connection quality parameter of a connection between each of the network nodes and an adjacent network node thereof in the topological connection relationship and a connection quality parameter of a connection between each of the network nodes and an idle node in accordance with the communication quality parameters, the bandwidth parameters, and a connection quality look-up table,
wherein the connection quality look-up table comprises a bandwidth reference, a plurality of connection quality references, and three communication quality ranges, and the connection quality references correspond to the bandwidth reference and the three communication quality ranges;
obtaining a plurality of candidate paths of the idle node in the mesh topology in accordance with the topological connection relationship, wherein the candidate paths are formed by connecting different combinations of the network nodes with the idle node;
calculating a path quality parameter of each of the candidate paths in accordance with the connection quality parameter of each of the connections in each of the candidate paths; and
selecting one of the candidate paths as a networking path for the idle node according to the path quality parameters of the candidate paths to join the mesh topology of the wireless network.

2. The method according to claim 1, wherein the step of obtaining the connection quality parameter of the connection further comprising:
in response to the relationship between the communication quality parameter corresponding to the connection and the three communication quality ranges, to select one from the three connection quality references; and
calculating the connection quality parameter of the connection according to the selected connection quality reference and a ratio of the bandwidth parameter corresponding to the connection to the bandwidth reference.

3. The method according to claim 2, wherein, the ratio of the bandwidth parameter corresponding to the connection to the bandwidth reference is multiplied by the selected connection quality reference to obtain the connection quality parameter of the connection.

4. The method according to claim 1, wherein the connection quality look-up table comprises a plurality of the bandwidth references, the connection quality references correspond to the bandwidth references and the three communication quality ranges.

5. The method according to claim 4, wherein a corresponding one of the bandwidth references and a corresponding one of the three communication quality ranges of the connection quality look-up table are selected as a selected one of the bandwidth references and a selected one of the communication quality ranges in accordance with the communication quality parameter and the bandwidth parameter which correspond to each of the connections, and the connection quality reference which corresponds to the selected one of the bandwidth references and the selected one of the communication quality ranges is taken as the connection quality parameter of the connection.

6. The method according to claim 1, further comprising adjusting the connection quality references of the connection quality look-up table in accordance with a channel parameter value corresponding to a channel at which each connection is located.

7. The method according to claim 1, further comprising:
normalizing the communication quality parameters so as to obtain the connection quality parameter of the connection between each of the network nodes and the adjacent network node thereof in the topological connection relationship and the connection quality parameter of the connection between each of the network nodes and the idle node.

8. The method according to claim 1, wherein the path quality parameter of each of the candidate paths is calculated in accordance with each of the connections in each of the candidate paths, a total number of the connections in each of the candidate paths, and the connection quality parameter of each of the connections in each of the candidate paths.

9. The method according to claim 1, wherein the network nodes comprise a root node, and the path quality parameter of each of the candidate paths is calculated in accordance with the connection quality parameter of each of the connections in each of the candidate paths, a connection spacing number between each of the connections and the root node in each of the candidate paths, and a hop adjustment parameter.

10. The method according to claim 9, wherein the path quality parameter of each of the candidate paths is calculated in accordance with the connection spacing number between each of the connections and the root node in each of the candidate paths, a total number of the connections in each of the candidate paths, the connection quality parameter of each of the connections in each of the candidate paths, and the hop adjustment parameter.

11. A wireless network, comprising:
a plurality of network nodes interconnected to form a mesh topology;
wherein one of the network nodes which is defined as a controller node is configured to:
obtain a communication quality parameter and a bandwidth parameter of each of the network nodes;
obtain a topological connection relationship of the network nodes in the mesh topology;
obtain a connection quality parameter of a connection between each of the network nodes and an adjacent network node thereof in the topological connection relationship and a connection quality parameter of a connection between each of the network nodes and an idle node in accordance with the communication quality parameters, the bandwidth parameters, and a connection quality look-up table,
wherein the connection quality look-up table comprises a bandwidth reference, a plurality of connection quality references, and three communication quality ranges, and the connection quality references correspond to the bandwidth reference and the three communication quality ranges;
obtain a plurality of candidate paths of the idle node in the mesh topology in accordance with the topological connection relationship, wherein the candidate paths are formed by connecting different combinations of the network nodes with the idle node;
calculate a path quality parameter of each of the candidate paths in accordance with the connection quality parameter of each of the connections in each of the candidate paths; and
selecting one of the candidate paths as a networking path for the idle node according to the path quality parameters of the candidate paths to join the mesh topology.

12. The wireless network according to claim 11, wherein the connection quality parameter of the connection is obtained further comprising:
in response to the relationship between the communication quality parameter corresponding to the connection and the three communication quality ranges, to select one from the three connection quality references; and
wherein the connection quality parameter of the connection is calculated according to the selected connection quality reference and a ratio of the bandwidth parameter corresponding to the connection to the bandwidth reference.

13. The wireless network according to claim 12, wherein the ratio of the bandwidth parameter corresponding to the connection to the bandwidth reference is multiplied by the selected connection quality reference to obtain the connection quality parameter of the connection.

14. The wireless network according to claim 11, wherein the connection quality look-up table comprises a plurality of the bandwidth references, the connection quality references correspond to the bandwidth references and the three communication quality ranges.

15. The wireless network according to claim 14, wherein the network node which is defined as the controller node selects a corresponding one of the bandwidth references and a corresponding one of the three communication quality ranges of the connection quality look-up table as a selected one of the bandwidth references and a selected one of the communication quality ranges in accordance with the communication quality parameter and the bandwidth parameter which correspond to each of the connections, and the connection quality reference which corresponds to the selected one of the bandwidth references and the selected one of the communication quality ranges is taken as the connection quality parameter of the connection.

16. The wireless network according to claim 11, wherein the controller node adjusts the connection quality references of the connection quality look-up table in accordance with a channel parameter value which corresponds to a channel at which each connection is located.

17. The wireless network according to claim 11, wherein the controller node normalizes the communication quality parameters so as to obtain the connection quality parameter of the connection between each of the network nodes and the adjacent network node thereof in the topological connection relationship and the connection quality parameter of the connection between each of the network nodes and the idle node.

18. The wireless network according to claim 11, wherein the controller node calculates the path quality parameter of each of the candidate paths in accordance with each of the connections in each of the candidate paths, a total number of the connections in each of the candidate paths, and the connection quality parameter of each of the connections in each of the candidate paths.

19. The wireless network according to claim 11, wherein the network nodes comprise a root node, and the controller node calculates the path quality parameter of each of the candidate paths in accordance with the connection quality parameter of each of the connections in each of the candidate paths, a connection spacing number between each of the connections and the root node in each of the candidate paths, and a hop adjustment parameter.

20. The wireless network according to claim 19, wherein the controller node calculates the path quality parameter of each of the candidate paths in accordance with the connection spacing number between each of the connections and the root node in each of the candidate paths, a total number of the connections in each of the candidate paths, the connection quality parameter of each of the connections in each of the candidate paths, and the hop adjustment parameter.
